(19) United States
(12) Patent Application Publication
(10) Pub. No.: US 2013/0013478 A1
(43) Pub. Date: Jan. 10, 2013

(54) SYSTEM AND METHOD FOR INCENTIVIZING RETIREMENT SAVINGS

(76) Inventor: Jonathan Broadbent, Lyndhurst, OH (US)

(21) Appl. No.: 13/543,368

(22) Filed: Jul. 6, 2012

Related U.S. Application Data
(60) Provisional application No. 61/505,776, filed on Jul. 8, 2011.

(51) Int. Cl. G06Q 40/06

(52) U.S. Cl. 705/35

(57) ABSTRACT

Systems and methods are provided to facilitate incentivization for participation in a financial plan, such as a retirement savings plan. Incentives are provided to encourage increased contribution and activity with the financial plan, with the goal of accumulation of enough assets to ensure future financial security, such as provision of adequate retirement income. Incentives can be provided by third party providers such as coupons, merchandise, services, etc. In return for provision of such incentives, third party providers can receive data, etc., in return, where the data can provide information on who is using their incentive, etc., which the third party provider can utilize as part of a marketing operation, for example. Hence the costs of the incentives are offset by the data provided.

### CROSS-REFERENCE TO RELATED APPLICATION

This application claims benefit of U.S. Provisional Patent application Ser. No. 61/505,776 entitled SYSTEM AND METHOD FOR INCENTIVIZING RETIREMENT SAVINGS, filed Jul. 8, 2011, the entirety of which is hereby incorporated by reference.

### TECHNICAL FIELD

The subject specification relates generally to financial services and in particular to incentivization of contributions to a retirement savings plan.

### BACKGROUND

Many Americans have little or no savings set aside for retirement. Employers have utilized various tactics, such as financial education and matching contributions, to encourage worker participation in retirement savings plans. However, in spite of these efforts, employee contributions remain low.

Over time, there has been a shift from employer funded retirement pensions to employee funded retirement plans such as the 401(k). Pensions have been disappearing for decades, as business owners transfer the obligation of retirement income preparation to employees. Employee participation in a 401(k) plan is typically voluntary. Plans similar to 401(k) plans are available to employees who work for non-profit organizations (e.g., 403(b) plans) or for government (e.g., 457 plans, the Thrift Savings Plan).

A survey released by the Employee Benefit Research Institute in 2010 revealed that the percentage of American workers with very little retirement savings grew for the third straight year. According to the Retirement Confidence Survey, the percentage of workers who have less than $10,000 in retirement savings grew to 43%, with 27% having less than $1,000. When asked, workers give a variety of reasons for not participating in a retirement savings plan. Many of these are economic—they can't afford to contribute, they don't want to tie up their money, or feel they don't need the coverage. Others claim that they don't understand the plan, don't have enough information or just haven't gotten around to it. Often, workers who do contribute do not contribute sufficiently to assure themselves a comfortable retirement. Low 401(k) participation and savings threaten to derail the retirement plans of millions of Americans.

Employers typically use several different policy options to encourage worker participation in 401(k) plans. A great number of employers offer to match employee contributions. Many employers provide workers with financial education concerning the need for adequate retirement savings or automatically enroll employees in 401(k) plans as the default option. However, in spite of these efforts, employee contributions remain low and many are unprepared for retirement.

At the same time, Social Security is under considerable and growing strain. Baby boomers are retiring and people are simply living much longer than the system, which was conceived in the 1930's, ever anticipated. Social Security began running a yearly deficit, when looking at the program's tax revenues compared to what it must pay out in benefits, in 2010. Most workers realize that they must provide for their own retirement and that it would not be wise to rely on Social Security as a source of retirement income. Yet the savings rate, based on various retirement plan data collected over decades, is far too low to adequately fill the gap. Some workers are planning to stay in the workforce longer to compensate.

Workers are responsible for managing the investments in their 401(k) plans. However, many workers are uninformed about financial markets and lack interest in spending their time learning about them. This lack of understanding leads to insufficient diversification between stocks and other instruments such as bonds. Consequently, a large number of participants in retirement plans have either defaulted into money market funds out of neglect, opted to go there out of market fear, or moved into them at the worst possible times (i.e. when the market dips), ultimately falling woefully short of an amount sufficient to maintain them through retirement.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

The various exemplary, non-limiting embodiments presented herein relate to systems and methods for provisioning of an incentivization process for provisioning at least one reward in acknowledgement of a participant satisfying one or more criteria relating to a financial plan. In an exemplary, non-limiting embodiment, the financial application is a retirement pension plan.

A system for providing a rewards program is established whereby at least one reward can be obtained from a third party provider. Further, details regarding one or more financial plans can be received by the rewards program, where the one or more financial plans are provided by a plan provider, such as a provider of retirement pension plans. The details of the one or more financial plans include information regarding at least one contributory level to the one or more financial plans. Further, for each contributory level, a criteria, requirement, rule, of other means for determining eligibility, is established. Each contributory level is associated with a reward received from the third party provider.

Upon successfully meeting the criteria, for example, the contributory level is matched, the reward associated with the contributory level is made available to the participant who successfully met the criteria.

A unique identifier can be associated with a reward to facilitate tracking of the reward through the system, e.g., generation of a reward associated with a contributory level. Upon successfully fulfilling a criteria of eligibility for the reward, data associated with the participant fulfilling the criteria can be combined with the unique identifier. The combination of unique identifier (and hence associated reward) and participant data can be forwarded to the third party provider. Hence, while the third party provider incurs cost associated with provisioning the reward (e.g., cost to third party provider in provisioning the product associated with the reward), the cost of the reward can be offset against finances employed by the third party provider in such budgets as marketing and advertising.

While reviewing a financial plan, and contributory levels associated therewith, e.g., via a webpage, the various reward(s) can be presented for each contributory level to the participant. Hence, a participant may be incentivized to increase a level of contribution in terms of reaching a financial goal as well as in receiving a reward for their increased contribution.

### BRIEF DESCRIPTION OF THE DRAWINGS

Various non-limiting embodiments are further described with reference to the accompanying drawings in which:

FIG. 1 is a flow diagram illustrating an exemplary, non-limiting embodiment for incentivizing a financial plan.

FIG. 2 is a block diagram illustrating an exemplary, non-limiting embodiment for incentivizing a financial plan.

FIG. 3 is a block diagram illustrating an exemplary, non-limiting embodiment for incentivizing a financial plan.

FIG. 4 is a block diagram illustrating an exemplary, non-limiting embodiment for migration of an incentivized reward program.

FIG. 5 is a flow diagram illustrating an exemplary, non-limiting embodiment for identifying rewards in an incentivized financial plan.

FIG. 6 is a flow diagram illustrating an exemplary, non-limiting embodiment for associating a reward with a participant in an incentivized financial plan.

FIG. 7 is a flow diagram illustrating an exemplary, non-limiting embodiment for identifying an interest in a reward.

FIG. 8 is a flow diagram illustrating an exemplary, non-limiting embodiment for identifying a location associated with a reward.

FIG. 9 is a block diagram illustrating an exemplary, non-limiting embodiment for incentivizing a financial plan.

FIG. 10 illustrates an exemplary, non-limiting computing environment facilitating operation of one or more exemplary, non-limiting embodiments disclosed herein.

FIG. 11 illustrates an exemplary, non-limiting networking environment facilitating operation of one or more exemplary, embodiments disclosed herein.

### DETAILED DESCRIPTION

### Overview of Incentivized Financial Plan

As discussed in the Background, participation by an individual in a financial plan(s) can be of a level below that required to secure a given goal, such as a retirement fund. In the various exemplary, non-limiting embodiments presented herein, an incentivization scheme is presented to encourage participation and/or increase current participation, in a financial plan. In an exemplary, non-limiting embodiment the financial plan is a retirement savings plan. However, it is to be appreciated that the various embodiments presented herein are applicable to any financial plan where participation can be increased by the utilization of incentives such as rewards (whether financial or of a non-financial nature), coupons, merchandise, services, products, goods, etc. According to various exemplary, non-limiting embodiments presented herein, various operations are presented for creating and implementing a financial plan. For example, where the plan is a retirement savings incentive plan, the various operations may include, but not limited to, any of the following:

(a) collecting and storing data records associated with at least one of an incentive reward, a participant of a financial plan, any of past, current, or future contribution(s) to at least one financial plan, at least one rule for eligibility of participation in a incentive program, etc.

(b) determining an eligibility of a participant to partake in an incentive program and receive at least one incentive based reward. In an exemplary, non-limiting embodiment, eligibility can be based on requirements/restrictions associated with the at least one reward. In other exemplary, non-limiting embodiments, eligibility can be based on the retirement plan participant, the retirement plan contribution, and any other rule, requirement, criteria, condition, regarding an incentive reward.

(c) outputting a determined eligibility, wherein the eligibility may be associated with at least one requirement associated with at least one reward, for example, a reward is only available (i.e., participant is eligible) when the participant has defined that they will be making a contribution of X dollar amount, or will be increasing their contribution by X dollar amount, and the like.

(d) communicating the determined eligibility of the at least one reward to the participant.

(f) upon determination of satisfaction of compliance with an eligibility of the reward (e.g., has made a defined contribution), providing the participant with the reward. The reward can be provided in any suitable format, e.g., electronic format such as a printable coupon, delivery by mail, redemption by the participant going to a specific location (e.g., a service shop for motor vehicle based services), etc.

(g) capturing data associated with at least one of the reward and/or the participant.

(h) associating the reward data with the participant.

(i) providing the associated reward-participant data to at least one of the reward provider (e.g., the third party provider), the financial plan provider, the participant, the entity provisioning the financial plan to the participant (e.g., the participants employer), reward program provider, etc.

According to other exemplary, non-limiting embodiments, a system for creating and implementing a retirement savings incentive plan can include any of the following:

(a) a provider of a financial plan, e.g., a enterprise providing a retirement plan.

(b) a third party providing at least one reward for application to the retirement plan.

(c) a reward service provider that acts as an intermediary between the third party reward provider and the financial plan provider, whereby the reward service provider can act to interact with the financial plan provider to identify particular contribution levels and, based thereon, identify which reward(s) provided by at least one third party is to be associated with which particular contribution level.

(d) where the financial plan is hosted by an entity associated with the participant (e.g., the financial plan is sponsored by the participants employer), the entity such as an employer.

(e) a participant interface configured to facilitate presentation of data to a participant looking to contribute, make increased contributions to a financial plan.

(f) at least one reward or incentive, where the reward/incentive can be in any suitable format such as electronic format such as a printable coupon, delivery by mail, redemption by the participant going to a specific location (e.g., a service shop for motor vehicle based services), etc.

(f) at least one interface between any of the aforementioned entities, wherein the at least one interface is configured to receive/process/transmit any data pertaining to any aspects of the various embodiments presented herein, the data relating to at least one reward, at least one financial plan, at least one participant engaged, about to engage, or potentially going to engage, in a financial plan, data relating to one or more levels of contribution to a financial plan, data relating to the third party reward provider, data relating to the provider of the financial plan, data relating to the sponsor (e.g., the participants employer) of the financial plan, at least one rule associated with an eligibility associated with at least one of a reward, a contribution level, a reward identifier facilitating tracking of the reward throughout the system and further to facilitate association of the reward with a participant to facilitate data mining, data tracking, etc., between a reward and a participant, wherein any of the components associated with the system (e.g., any of (a)-(f) above) can have associated therewith necessary components, devices, etc., to facilitate operation of the system in its various exemplary, non-limiting embodiments, as presented herein. Where such components, devices, etc., can comprise of at least one memory device, at least one processor, at least one output module, at least one input module, a graphical interface supporting display of such components as a web page(s), etc.

Systems and methods of the present disclosure encourage participants to make retirement plan contributions by providing incentive rewards which are made available directly to the participant as a result of making a contribution, increasing the value of a current contribution amount, satisfying some other eligibility criteria, and the like. In an exemplary, non-limiting embodiment, the incentive rewards can be provided by a third party. For example, the third party may be a provider of products, services, etc. In an exemplary, non-limiting embodiment an incentive reward(s) can be made available to the retirement plan participant at no cost to either the participant or the provider of the financial plan. The various exemplary, non-limiting embodiments presented herein can be of interest to an incentive reward provider (e.g., the third party provider) as various aspects presented herein can function as means for generating sales, increase the visibility of the third party provider in the market place, generate further sales, increase customer loyalty, etc. For example, as rewards are presented to a participant (e.g., via a graphical user interface presenting a webpage), firstly the participant is exposed to the reward(s) regardless of whether the participant ultimately chooses the reward, and further by choosing a particular reward a participant may deem the third party provider to provide a product, service, etc., that the participant further utilizes, purchases, frequents, etc., outside of the incentivization reward process as presented herein.

An incentive reward can encourage participation in a financial plan by engendering in an individual to focus on their future financial need(s), such as planning for retirement. Individuals that have minimal, if any participation in such financial plans can be activated into participation, while others may find the rewards program provides a form of financial discipline and facilitates focus on a financial goal, such as increasing retirement savings. Participants may define their financial goal(s) (e.g., X amount of dollars in a retirement fund) and then receive rewards for meeting or exceeding the financial goal(s). In an exemplary, non-limiting embodiment, the participant may pledge to achieve a particular financial goal over a defined period. For example, the participant may pledge to contribute a specific dollar amount or a percentage of income over the course of a year. In another exemplary, non-limiting embodiment participant eligibility for one or more of the incentive reward(s) may be conditioned on meeting or exceeding a previously established financial goal. In another exemplary, non-limiting embodiment, incentive reward eligibility rules or criteria may be established by a program administrator, a participant, an incentive reward provider, an employer, a retirement plan sponsor, a retirement plan provider, a retirement plan administrator, or other associated with the incentive scheme.

In certain embodiments, eligibility for incentive rewards may be conditioned on a participant maintaining sufficient investment diversification within their retirement account. Incentive rewards may also be conditioned on appropriate portfolio adjustments.

The systems and methods of the present disclosure may be implemented for any type of retirement savings including, without limitation, 401(k) plan, 403(b) plan, 457(b) plan, various IRA accounts or other types of retirement savings financial vehicles. The participant retirement account may be established at, for example, a bank, mutual fund company, brokerage, investment company or other financial institution.

In accordance with aspects of the present disclosure, a participant may offset the contributions made to their retirement account with incentive rewards, in essence funding their retirement at little or no cost. For example, a participant receiving a $10.00 discount on a monthly car payment, a 0.5% reduction on their mortgage, an additional 0.25% in interest on their savings account, reduced travel costs from airlines and rental car companies and other discounts, may offset the contribution deferred into their retirement account.

### Description of an Incentivized Financial Plan

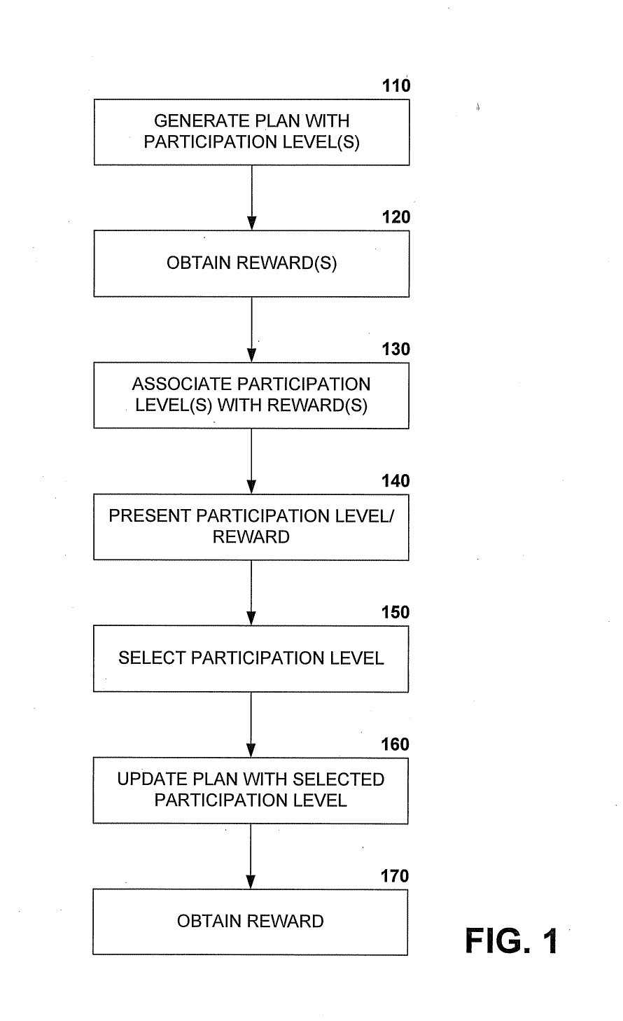

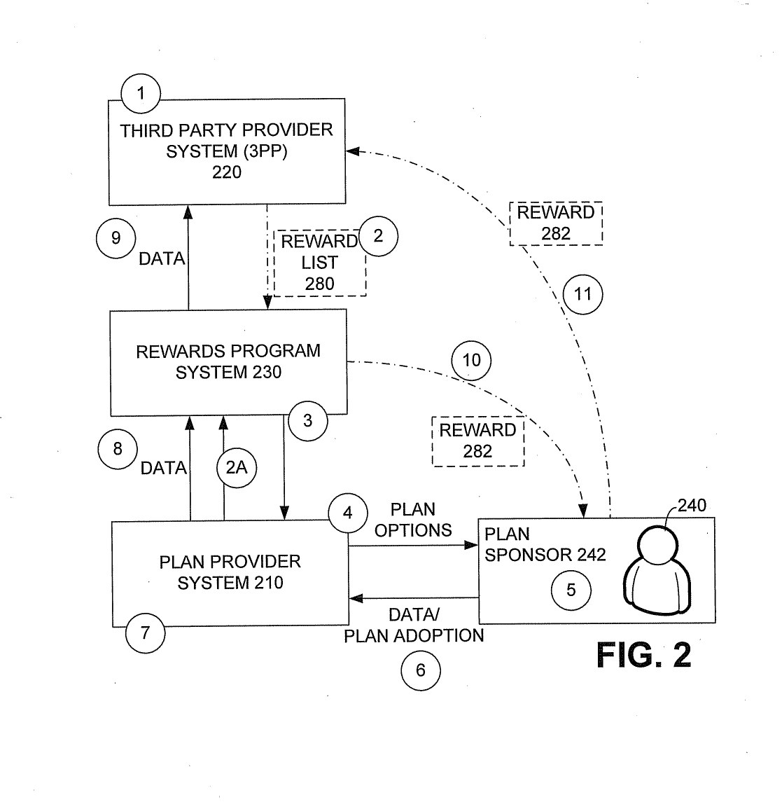

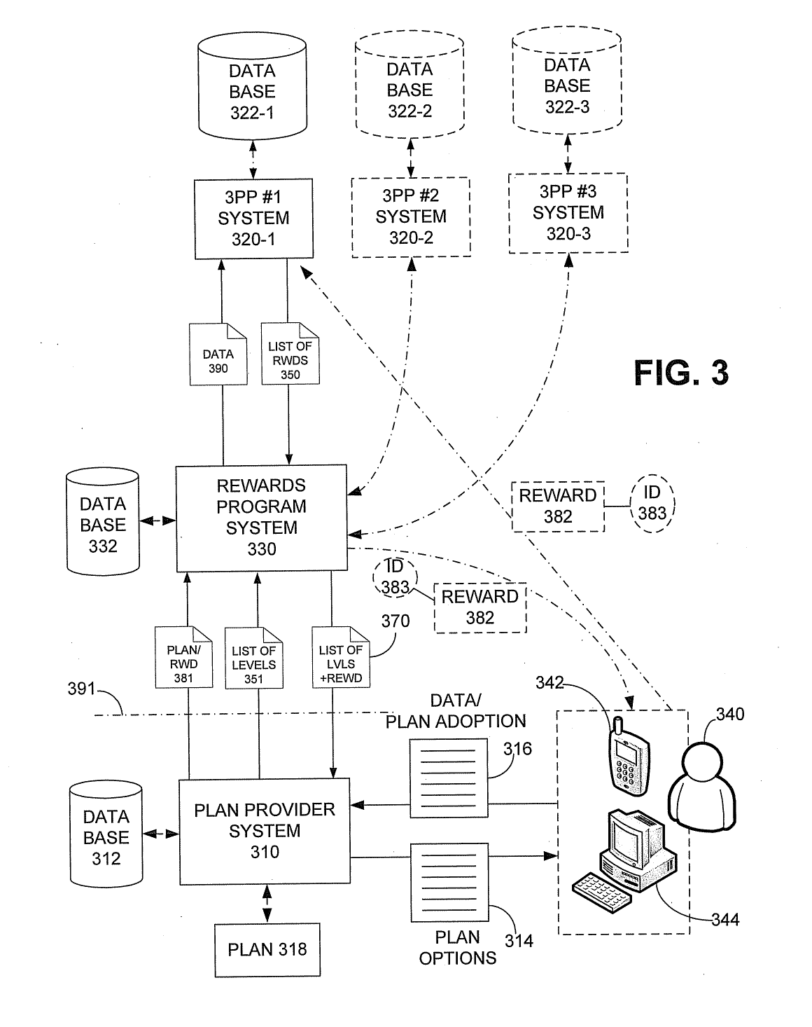

With respect to one or more exemplary, non-limiting embodiments of the incentivization application as described above, FIG. 1 illustrates a flow diagram illustrating an exemplary, non-limiting embodiment for incentivizing a financial plan. For the purposes of description and understanding, the flow is presented with reference to various components, active parties, etc., as depicted in subsequent FIGS (e.g., FIGS. 2 and 3). At 110, a financial plan (e.g., a retirement plan 318—provided by plan provider system 310) is generated with various participation levels (e.g., list of levels 351) of participation identified therewith. For example, percentage change in contribution can be associated with real actual dollar amounts. The financial plan can be provided by a financial provider (e.g., plan provider system 310) to a rewards program system (RPS) (e.g., rewards program system 330).

At 120, at least one reward (e.g., list of rewards 350) can be obtained, wherein the at least one reward can be provided by a third party provider (3PP) (e.g., any of 320-1, 320-2, 320-3) to the RPS. The 3PP can be a provider of any service(s), product(s), good(s), etc., of interest to any current or future participant of the incentivization application.

At 130, the various participation level(s) can be associated with any of the reward(s). The association of participation level(s) with a reward can be performed by any of the various entities involved in the incentivization application. For example, an entity operating the RPS can facilitate control of which reward goes with which participation level, and hence, the RPS can facilitate forwarding of a reward to a participant while provisioning data regarding the reward and/or the participant to the 3PP. The 3PP can subsequently utilize the participant/reward data for such purposes as marketing, where the participant/reward data can provide information such as age, gender, geographic location, etc., of a participant who has selected a reward of the 3PP.

At 140, the reward(s) for a participation level(s) can be presented to a person (e.g., 340) reviewing their contribution to the financial plan, e.g., a person looking to start contributing to a pension plan, or increase their contributions to a pension plan, etc. The reward(s) can be presented via a graphical user interface (GUI) which can be presented on a computer (e.g., computer 344) or other suitable device such as a mobile phone (e.g., mobile device 342). Wherein the GUI can be utilized to present a financial plan as a webpage (e.g., plan options page 314) or other suitable means for conveyance of plan/reward information along with facilitating interaction by a user in selecting a plan along with selection of a reward associated therewith. For example, plan option screen 314 can provide information regarding current contribution rate, along with other prospective contribution rate(s), whereby for each contribution rate one or more rewards can be presented therewith to facilitate ready determination of which reward(s) are available for a given contribution level(s). For example, at a lower level increase in contribution (e.g., increasing from a current contribution rate of 2% of annual salary to 3% of annual salary) a reward may comprise of a low monetary value such as a voucher for a meal at a restaurant. However, at a higher level of increase in contribution (e.g., increasing from a current contribution rate of 2% of annual salary to 7% of annual salary) a reward may comprise of a higher monetary value such as a voucher for reimbursement for a bicycle, or associated goods, by a bicycle manufacturer up to a given dollar amount, such as $400 maximum. It is to be appreciated that any number of reward(s) can be associated with a given participation level, wherein the reward(s) may be provided by a single 3PP (e.g., any of 320-1, 320-2, 320-3) to a multiple of 3PPs (e.g., all of 320-1, 320-2, 320-3).

At 150, the participant selects the level of participation in the financial plan. For example, owing to the previous example of reward, one participant who is an avid cyclist may be swayed by the incentive of obtaining a bicycle and is thus compelled to increase their current contribution level to 7%. Alternatively, another participant may be of lesser financial means and thus wants to participate at an increased, but lower level, and thus increases their contribution from a current level of 2% to 3%, and in doing so obtains a voucher for a meal at a restaurant.

At 160, the financial plan, upon receipt of the selection of the desired participation level, is updated in accord with the desired participation level. Further, any financial institute associated with the participant's contributions can also be informed of the contribution change, such as a bank associated with the participant, wherein a direct debit from a bank account of the participant is adjusted in view of the change in contribution level.

At 170, in accord with the updated contribution level, the participant can obtain/receive the reward. As previously mentioned, the reward can be provided in any suitable format, e.g., electronic format such as a printable coupon, delivery by mail, redemption by the participant going to a specific location (e.g., a service shop for motor vehicle based services), etc.

Turning to FIG. 2, presented is a block diagram illustrating an exemplary, non-limiting embodiment for incentivizing a financial plan. FIG. 2 is presented to facilitate understanding of the various exemplary, non-limiting embodiments presented herein, whereby acts presented in FIG. 1, are associated with entities, etc., comprising an incentivization application, as further depicted in FIG. 3. At (1) a 3PP 220 is engaged by a rewards program system (RPS) 230, whereby at (2) the 3PP can provide one or more rewards (e.g., in reward list 280) for utilization in the incentivization program. At (2A), the provider of the financial plan, plan provider system 210, provides information regarding what plan(s) (e.g., plan 318) are to be offered and various levels of contribution for a given plan. At (3), RPS 230 can associate one or more rewards comprising reward list 280 with a given participation level.

At (4) the plan(s) and associated reward(s) can be forwarded to a plan sponsor 242 (e.g., a participant's employer). In an exemplary, non-limiting embodiment, it is considered that the rewards program system 230 will interface with the plan provider system 210, however the plan sponsor 242 will only have access to webpage(s) provided by the plan provider 210 (e.g., for the interests of information security regarding the participant, the plan provider, the plan sponsor, etc.).

At (5) the various plan(s) and reward(s) can be presented by the sponsor 242 to the participant 240. For example, the plan(s) and reward(s) may be offered as part of an employment package provide by participant's 240 employer. In another aspect participant 240 can directly engage with the plan provider 210 without going through a employee plan (e.g., the participant has a personal plan which they engage with directly as opposed to a plan provided by an employer).

At (6), a plan is selected by participant 240 and forwarded via the plan sponsor 242 to the plan provider 210. At (7) the plan provider 210 can perform any necessary actions to facilitate adoption of the new plan, such as updating internal databases with the details of the new plan, e.g., selected contribution rates.

At (8) any data regarding the participant 240, selected reward 282, plan information 318, plan sponsor 242, plan provider 210, etc., can be forwarded from the plan provider 210 to RPS 230. It is to be appreciated that the forwarded data is constrained in accordance with any associated data secrecy measures such as a personal data privacy and security act, and the like. Hence, only data available for dissemination may be provided by the plan provider 210 to RPS 230 thereby preventing exposure of any secure, personal data by plan provider system 210.

At (9) RPS 320 can analyze the data received from the plan provider system 210 and extract such information as details associated with the participant 240 who selected a particular reward 282. In an aspect, as described further herein, each reward can have associated therewith a tracking identifier such that any given reward 282 can be uniquely associated with a given participant 240. Hence, 3PP 220 can receive data of which reward was selected along with information associated with the participant 240 who selected the reward.

At (10) a selected reward 282 can be forwarded (and/or retrieved) from RPS 230 to the participant 240. As previously mentioned the reward 282 can be in any suitable form such as electronic, printed mailed coupon, reward redeemable at a specific location, etc.

At (11) the reward 282 can be redeemed at the 3PP 220. For example, the reward can be a dinner voucher and thus the participant 240 eats the meal at the restaurant associated with 3PP 220. In another aspect, the reward 282 is a physical object, e.g., a pair of shoes, which can be mailed to the participant 240, etc.

FIG. 3 is a block diagram illustrating an exemplary, non-limiting embodiment for incentivizing a financial plan, e.g., plan 318. Illustrated is a plurality of 3PP's 320-1, 320-2, and 320-3 interacting with a rewards program system (RPS) 330. 3PP systems 320-2 and 320-3 are depicted in broken line to indicate interaction with RPS 330 while discussion will focus on 3PP 320-1, operation with 320-2 and 320-3 can be considered to be of a similar manner. 3PP 320-1 has associated therewith a database 322-1, wherein database 322-1 can be configured to store information regarding one or more rewards (e.g., reward 382) along with data 390 which may be provided by rewards program system 330. For example, data 390 may be data associated with a participant 340 who has selected a particular reward 382, and thus facilitates data mining, etc., by the marketing department, or other similar entity, that is looking to identify which portions of a given population are interested in one or more products, services, etc., provided by 3PP 320-1, for example.

3PP 320-1 can provide RPS 330 with a list 350 detailing which rewards 3PP 320-1 wishes to provide as part of an incentivization program. In certain embodiments, 3PP 320-1 may be a local business providing an incentive reward (e.g., reward 382) in recognition of the participant's 340 contributions to a retirement plan 318 provided by plan provider system 310. A local incentive reward provider may include a local retailer, a restaurant, bakery, candy shop, toy store, automobile dealership, bank, and the like. Incentive rewards (e.g., reward 382) provided by the 3PP 320-1 may include, for example, goods or services offered to the participant at a discount or at no cost or may take the form of gift certificates, gift cards or coupons. For example, an automobile dealer may provide favorable automobile lease terms or a discounted automobile purchase price or rebate. As another example, a financial institution may offer a premium interest rate on savings accounts or certificates of deposit, or a lower mortgage interest rate or reduced closing costs on a mortgage.

In other embodiments, 3PP 320-1 may be a national business providing an incentive reward 382 in recognition of the plan participant's 340 contributions to a plan 318 offered by plan provider system 310. A national incentive reward provider may include, for example, a national retailer, a restaurant, financial institution, automobile manufacturer, and the like.

In other embodiments, 3PP 320-1 may be the participant's 340 employer or the retirement plan sponsor. The employer may also be the retirement plan sponsor. Incentive rewards 382 provided by an employer or other retirement plan sponsor may include, for example, concierge service for everyday errands, cafeteria discounts, reserved parking, on-site massage or access to a fitness center.

According to further embodiments, an incentive reward 382 may be provided in the form of a list or searchable database of recommended service providers, for example, financial advisors such as Certified Financial Planners and the like.

In still further embodiments, 3PP 320-1 may be the retirement plan provider system 310, for example, FIDELITY, VANGUARD, AMERICAN FUNDS, TRANSAMERICA, GREAT WEST, TD AMERITRADE, CHARLES SCHWAB, and the like. Plan provider system 310 may offer incentive rewards 382 in the form of discounted or waived fees, for example, annual fees to open or maintain a brokerage account, brokerage trading costs, purchasing non-proprietary funds and the like.

Further, plan provider system 310 can provide details 351 of which plan(s) are offered along with details pertaining to contributory amounts associated with a given plan. Wherein, database 312 associated with plan provider system 310 can store data relating to plans offered, information pertaining to a participant (e.g., participant 340) etc.

RPS 330 can be configured to associate at least one plan, and contributory levels associated therewith, with at least one reward (e.g., reward 382) received in reward list 350. The list of contributory level and associated reward 370 can be provided to plan provider system 310 to facilitate population of information regarding plan option(s) 314, whereby plan options 314 can be presented to participant 340 electronically, e.g., via computer 344, or portable device 342, where plan options 314 can be in the form of a webpage configured for display by a browser associated with computer 344 or portable device 342. Alternatively, plan options 314 can be in the form of a printed page, or any other suitable format, to facilitate conveyance of information regarding a given plan, contributory levels and associated rewards to participant 340.

Upon presentation of plan options 314, participant 340 can select a desired contributory level, whereupon data regarding the adopted plan 316 can be forwarded to plan provider system 310. As identified by line 391, plan provider system 310 can be a secure system (e.g., operating behind an internet firewall) and thus the level of data exposed by the plan provider system 310 is controlled by the plan provider system 310. Hence, plan options 314 and data/plan adoption 316 can be controlled such that information presented therein is in result of an authentication process, e.g., the participant 340 authenticates themselves to plan provider system 310 via a password or other suitable means as known in the art. Hence, plan provider system 310 can control the degree of data exposed to RPS 330 and, further, to 3PP 320-1.

Upon receipt of the plan and contributory level selection 316 at plan provider system 310, information regarding the selected plan and reward 381 can be forwarded to RPS 330. As previously mentioned, a reward 382 can have associated therewith a unique identifier 383 which can be utilized to track the reward 382 (e.g., when and where the reward 382 was redeemed) as well as associating data pertaining to the participant (e.g., participant 340) who selected the reward. In an exemplary, non-limiting embodiment as the list of levels and associated rewards 370 is generated for forwarding to participant 340, upon selection of the plan 316 a message can be forwarded from the plan provider system 310 to RPS 330 indicating that a reward has been selected, whereupon the RPS 310 can generate a specific reward 382 having a unique identifier 383 associated therewith. The identifier 383 can be associated with participant 340 data thereby enabling the reward 382 to be uniquely associated with the participant 340. Hence, upon receiving plan-reward data 381 from the plan provider system 310, the reward data 390 associated with a reward can be forwarded to 3PP 320-1, whereupon it can be stored in the database 322-1 for subsequent analysis/data mining.

Further, RPS 330 can utilize the unique identifier 383 to generate a reward 382 for forwarding to the participant 340. For example, the reward 382 may be a voucher for a meal at a restaurant, where during generation of the reward 382 in electronic format identifier 383 is associated therewith, i.e., the identifier is converted to a bar code for scanning by a bar code reader or similar device. Hence; upon redemption of the reward 382 at an entity associated with 3PP 320-1, e.g., a restaurant, the bar code can be scanned and database 322-1 can be updated to indicate when, where, by whom, etc., the reward 382 was redeemed.

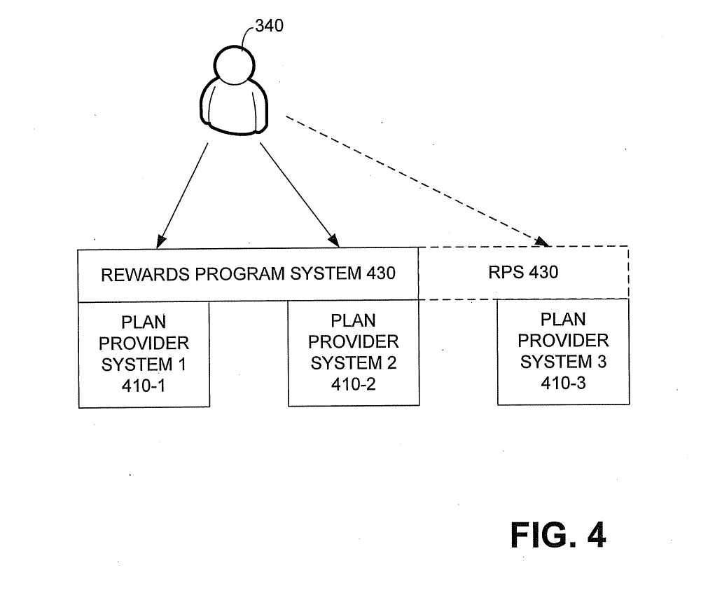

FIG. 4 is a block diagram illustrating an exemplary, non-limiting embodiment for incentivizing a financial plan. In an exemplary, non-limiting embodiment, the rewards program system 430 can be associated with a plurality of financial plans provided by a plurality of disparate plan providers (e.g., plan provider systems 410-1, 410-2, 410-3). Hence, while a particular plan provider system (e.g., 410-1) has provided data regarding plans offered and contribution levels associated therewith (e.g., FIG. 3, levels 351), and rewards can be associated therewith, per FIG. 3, list of levels and rewards 370, as second plan provider system (e.g., 410-2) can be associated with rewards program system 430. Hence, rewards from a 3PP (e.g., FIG. 3, 320-1) can be associated with plans/contribution levels for a first plan provider system as well as a second plan provider system.

Hence, when a participant 340 moves from one employer to another, the participant 340 may have to change the plan provider they are associated with (e.g., a previous employer utilizes plan provider system 410-1, while the current employer utilizes plan provider system 410-2) and thus participant 340 has to switch from a first plan provider to a second plan provider. However, owing to the rewards program system 430 being utilized by both the first plan provider (e.g., plan provider system 410-1) and the second plan provider (e.g., plan provider system 410-2), the participant 340 is still able to partake in the incentivization scheme offered by RPS 430. Further, on gaining employment at a third employer, it may occur that the plan provider system (e.g., plan provider system 410-3) does not currently engage in the incentivization program offered by the RPS 430, as indicated by the broken line. However, upon request of the participant 340, the RPS 430 can be extended to service the plan provider system 410-3, whereby a incentivization program (e.g., RPS 430) is made available to plan provider system 410-3, and in view of the adoption of RPS 430 by the plan provider system 410-3 plans and contribution levels, etc. (e.g., levels 351) can be identified and rewards (e.g., in rewards 350) can be associated therewith.

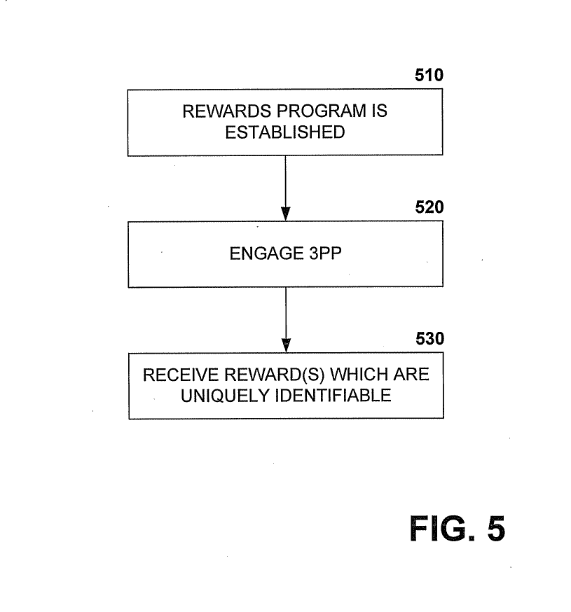

Turning to FIG. 5, illustrated is a flow diagram depicting an exemplary, non-limiting embodiment for incentivizing a financial plan. As previously mentioned, a reward can be uniquely associated with an identifier to facilitate tracking of the reward. At 510, a rewards program is established, whereby a plan provider (e.g., plan provider system 310) can provide information (e.g., list of levels 351) to a rewards program system (e.g., RPS 330) to facilitate association of reward(s) (e.g., reward 382) with various level(s) of contribution for the plan.

At 520, a third party provider (3PP) of reward(s) (e.g., 3PP 320-1) can be engaged by the rewards program system, whereby the 3PP can provide a list of rewards (e.g., list of rewards 350) which can be associated with the various level(s) of contribution for a given plan.

At 530, the various rewards are defined at the rewards program system and stored (e.g., in database 322), whereby a unique identifier (e.g., identifier 383) can be generated for each reward. In an exemplary, non-limiting aspect, the unique identifier can be generated by the third party provider to facilitate tracking of the coupon within the third party provider system. In another exemplary, non-limiting aspect, the unique identifier can be generated by the rewards program system, thereby enabling the rewards program system to uniquely associate the reward with a participant.

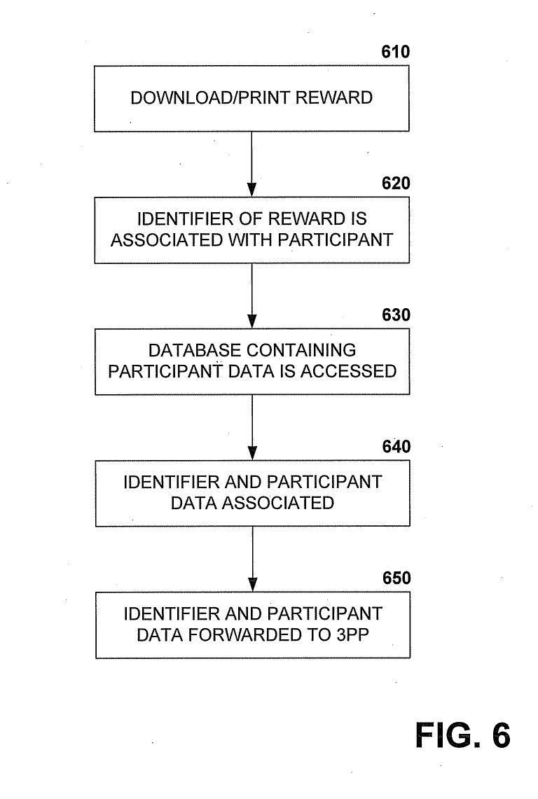

Turning to FIG. 6, illustrated is a flow diagram depicting an exemplary, non-limiting embodiment for tracking a coupon in an incentivized financial plan. As previously mentioned (e.g., in FIG. 5), a reward can be uniquely associated with an identifier to facilitate tracking of the reward. At 610, as previously described a participant (e.g., participant 340) can, upon satisfaction of at least one of an eligibility or rule, download a reward (e.g., reward 382) associated with a contribution in a financial plan (e.g., a plan generated by plan provider system 310). As mentioned, the reward can have a unique identifier (e.g., identifier 383) associated therewith. At 620, the unique identifier can be associated with the participant selecting the reward. For example, once the participant has fulfilled their contributory obligation, and hence become eligible for a reward, the unique identifier of the reward is associated with the recipient.

At 630, based upon the recipient being associated with the reward, a database (e.g., database 312 associated with plan provider system 310) can be accessed to retrieve information pertaining to the participant. Data pertaining to a participant can be retrieved from the database, while further data can be captured as the participant interacts with the plan provider system. For example, the participant can supplement data stored at the plan provider system with further data to facilitate improved generation of contribution levels, determination of a financial goal, etc., where the supplemental data can be further captured and stored in the plan provider system database.

At 640, the reward identifier and data associated with the participant can be combined. Hence, rather than the third party provider (e.g., 3PP 320-1) simply providing coupons for utilization in the incentivization program, the third party provider can use the reward(s) to obtain data regarding who is interested (e.g., selects) in their product, service, etc. Thus, the incentivization application can be utilized by the third party provider as a marketing tool, where the cost of advertising and/or obtaining data about a client base can be offset against the cost of providing a reward(s) to the incentivization program.

At 650, the reward identifier (and associated reward information) can be provided (e.g., by a rewards program system (e.g., RPS 330)) to the third party provider along with data pertaining to the participant who selected the reward. The identifier can be subsequently utilized to track when and where the reward was redeemed, e.g., cashed-in, exchanged for a product, etc.

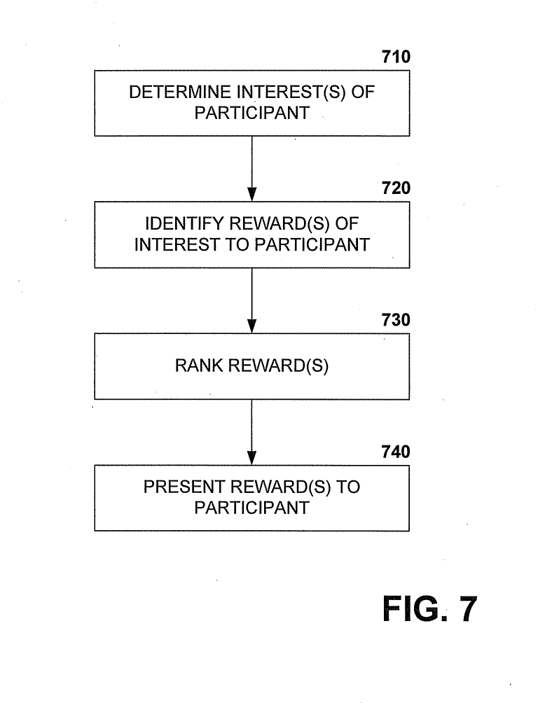

Turning to FIG. 7, illustrated is a flow diagram depicting an exemplary, non-limiting embodiment for presenting rewards in an incentivized financial plan. At 710, as previously mentioned, data pertaining to a participant (e.g., participant 340) can be retrieved from a database (e.g., database 312) associated with a plan provider system (e.g., plan provider system 310) to facilitate presentation of data, contribution levels, etc., to the participant by any suitable means such as via a plan options webpage (e.g., plan options 314). The data can be analyzed to determine an interest(s) of the participant. The data stored in the database can be further supplemented by the participant, whereby the participant can be prompted to indicate their interest(s) on a webpage, or similar collection means.

At 720, based on the available rewards (e.g., as identified in list 350) the rewards can be parsed based on the perceived interest to the participant.

At 730, based on the parse operation, the rewards can be ranked based on, for example, most interesting to least interesting, or other similar weighting mechanism.

At 740, based on the ranking, the rewards can be presented in a manner reflecting the reward with a highest anticipation of selection through to a reward with the least anticipation of selection. Based upon the reward selection, the stored data (e.g., in databases 312, 322-1, 322-2, 322-3, 332, etc.) can be updated, thereby enabling improved presentation of subsequent rewards as well as further data analysis for the third party provider (e.g., 3PP system 320-1).

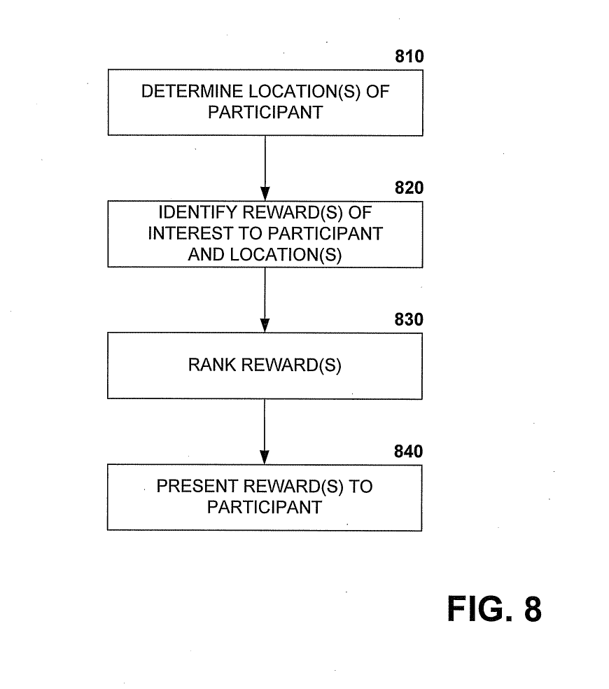

FIG. 8 illustrates a flow diagram depicting an exemplary, non-limiting embodiment for presenting rewards in an incentivized financial plan. At 810, as previously mentioned, data pertaining to a participant (e.g., participant 340) can be retrieved from a database (e.g., database 312) associated with a plan provider system (e.g., plan provider system 310) to facilitate presentation of data, contribution levels, etc., to the participant by any suitable means such as via a plan options webpage (e.g., plan options 314). The data can be further enhanced based on determination of a location of the participant at a given time. For example, a locating system (e.g., a global positioning system associated with mobile device 342) can be utilized to determine a location of the participant. It is to be appreciated that any suitable means for determination of location can be utilized.

At 820, based on the determined location the rewards available (e.g., rewards in list 350 or 370) can be parsed in accordance with the location of the participant. The rewards can be based simply on location or can be parsed based on location and of interest to the participant.

At 830, based on the location (and interest) the rewards can be ranked based on, for example, most interesting location reward to least interesting location reward, or other similar weighting mechanism. For example, a person may be on vacation and is also known by the incentivization system to be an avid scuba diver. Hence, a reward pertaining to scuba diving at the participants vacation location can be deemed to be of greater interest, than say, golf lessons at a golf course also located at the vacation location.

At 840, based on the ranking, the rewards can be presented in a manner reflecting the reward with a highest anticipation of selection through to a reward with the least anticipation of selection. Based upon the reward selection, the stored data (e.g., in databases 312, 322-1, 322-2, 322-3, 332, etc.) can be updated, thereby enabling improved presentation of subsequent rewards as well as further data analysis for the third party provider (e.g., 3PP system 320-1).

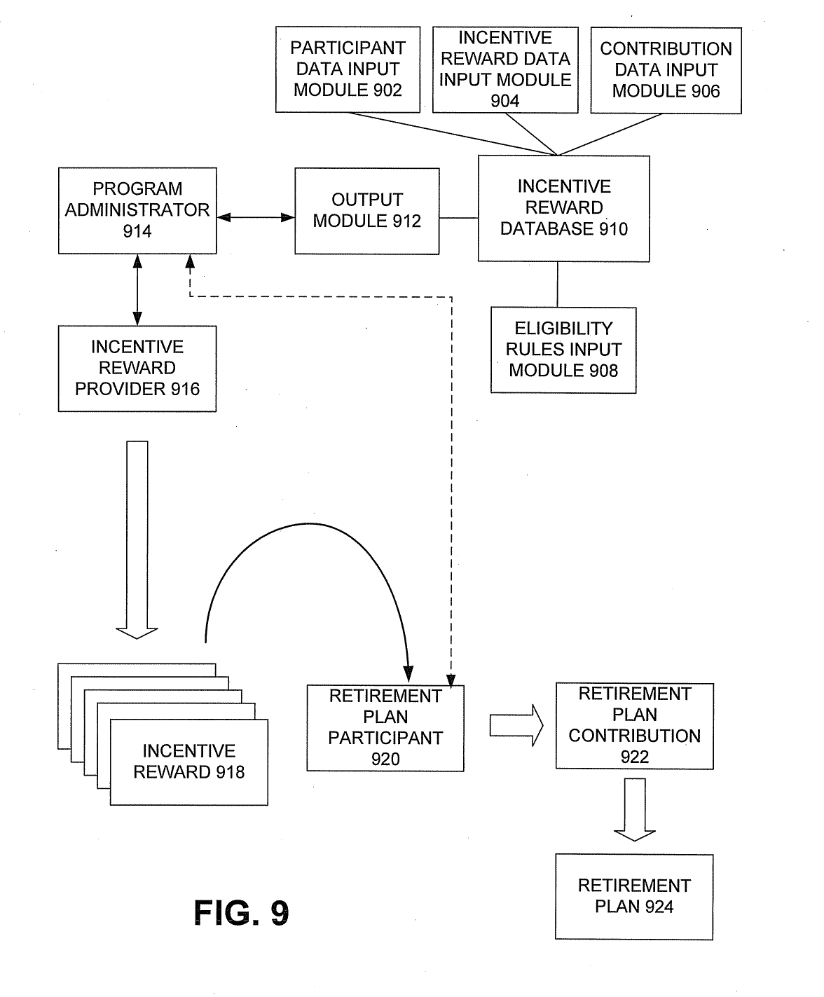

Turning to FIG. 9, in an exemplary, non-limiting embodiment, data representative of a participant (e.g., participant 340) in a retirement plan can be collected and entered through a participant data input module 902. Data representative of incentive rewards (e.g., reward 382) can be collected and entered through an incentive reward data input module 904. Data representative of retirement plan contributions can be collected and entered through a contributions data input module 906. Rules associated with determining a participant's eligibility to receive incentive rewards can be specified and entered through an eligibility rules input module 908.

Once the input data sets and eligibility rules have been prepared, an output may be generated, e.g., via output module 912, for use by a program administrator 914 or other entity. Examples of such output include spreadsheets, charts, plots, graphs and any other representation to identify information of interest. For instance, the output may present incentive rewards or retirement contributions on a user's display using images, colors, fonts, etc.

The program administrator 914 communicates with the incentive reward provider 916 (e.g., 3PP 320-1) and retirement plan participant 920 (e.g., participant 340). The incentive reward provider 916 can provide the incentive rewards 918 directly to the retirement plan participant 920 based on, for example, the participant's contribution 922 to a retirement plan 924.

In a further embodiment, an incentive reward is provided for contributing to a retirement account, for achieving a retirement savings goal or for exceeding a retirement savings goal. The goal may be established, for example, by a participant 920, the program administrator 914, an employer, a plan sponsor, an incentive reward provider 916, the retirement plan provider (e.g., plan provider system 310), the retirement plan administrator or others. Goals may be established and measured at some set time period, for example, monthly, semi-anually, annually, biennially or on a continuous basis. Goals may be included in the eligibility rules 908 used for determining a participant's eligibility to receive incentive rewards.

In another, exemplary, non-limiting embodiment, a participant (e.g., participant 340) may be provided with an incentive reward (e.g., reward 382) in the form of an award. The award may take the form of an achievement certificate, wallet card, key fob, trophy, plaque, medal, pin, ribbon or other such recognition award. Similar to other incentive rewards, the award may be conditioned on meeting or exceeding a previously established savings goal. A recognition award may be provided, may expire or be renewed at the end of a set time period such as annually. A recognition award may also be used to confirm the participant's eligibility for other incentive rewards. By way of example only, a participant may obtain a discount from an incentive provider, such as a retailer (e.g., 3PP 320-1), by presenting a wallet card recognition award to a store clerk at check out time.

In other embodiments, a participant (e.g., participant 340) may be informed of an available incentive reward (e.g., reward 382) by various communication means such as in-person meeting, email, voicemail, regular mail and the like. A participant 340 may also be provided with online access to incentive reward and retirement account information, for example, intranet or Internet access. Participant 340 may want to establish retirement savings goals and track progress utilizing, for example, a retirement savings incentive website. The website may contain a protected area where participant 340 may link to their retirement accounts, make changes or adjust their contributions. The website may contain a public area where incentive information may be made available, for example, a listing of incentive reward providers (e.g., 3PP's 320-1, 320-2, 320-3) and details regarding the type and availability of incentive rewards (e.g., rewards in last 350). Other information concerning incentive reward providers (e.g., 3PP's 320-1, 320-2, 320-3) and incentive rewards (e.g., rewards in last 350) may also be provided via a website, for example, for utilizing hyperlinks or click-through ads.

In accordance with aspects of the present disclosure, incentive rewards (e.g., rewards in list 350) may be targeted to appeal to a particular demographic or to support a particular cause. For example, a “green initiative” plan may include incentive rewards (e.g., rewards in last 350) concentrated on fostering a culture of environmental responsibility, focusing on sustainability or reducing environmental impact. Incentive rewards (e.g., rewards in list 350) may also be directed towards national or regional pride and feature appropriate incentive rewards.

In certain embodiments, metrics may be tracked to assess the impact of an incentive reward program on, for example, participation levels, retirement fund diversification and proximity to goals. The metrics may be shared with a participant, employer, plan sponsor, incentive reward providers or others. For example: (a) data related to an individual's retirement plan contributions and incentive rewards gained as a result of participation in the plan may be available to a participant, (b) data with regards to aggregate employee participation and incentives awarded may be made available to the employer and (c) data related to sales attributed to participation in the plan may be shared with an incentive provider (e.g., 3PP 320-1).

### Exemplary Computing Device

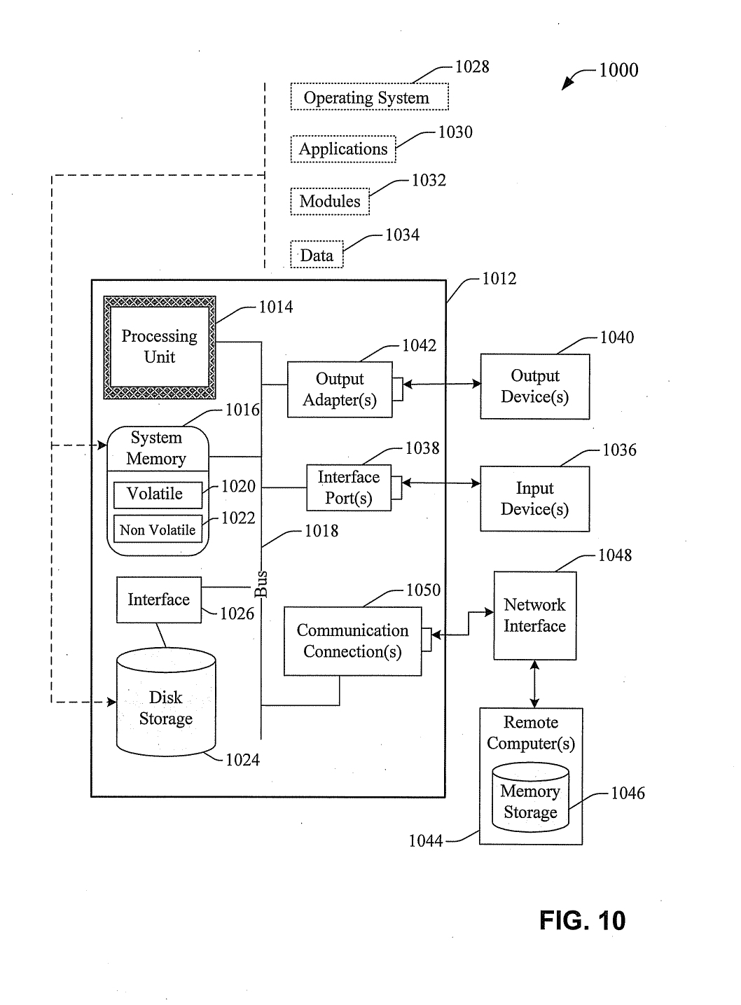

As mentioned, advantageously, the techniques described herein can be applied to any system supporting an incentivized application described herein. It can be understood, therefore, that handheld, portable and other computing devices and computing objects of all kinds are contemplated for use in connection with the various embodiments, i.e., generation and selection of rewards. Accordingly, the below general purpose remote computer described below in FIG. 10 is but one example of a computing device, where the computing device can comprise any of the interfaces and controller as presented above.

Embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 10 thus illustrates an example of a suitable computing system environment 1000 in which one or aspects of the embodiments described herein can be implemented, although as made clear above, the computing system environment 1000 is only one example of a suitable computing environment and is not intended to suggest any limitation as to scope of use or functionality. In addition, the computing system environment 1000 is not intended to be interpreted as having any dependency relating to any one or combination of components illustrated in the exemplary computing system environment 1000.

With reference to FIG. 10, an example environment 1010 for implementing various aspects of the aforementioned subject matter, including retaining documentation natively within memory of an industrial controller, includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures, including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable PROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices/1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

### Exemplary Networked and Distributed Environments

One of ordinary skill in the art can appreciate that the various embodiments of the jog request generation and control system and methods described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in video viewing and tagging mechanisms as described for various embodiments of the subject disclosure.

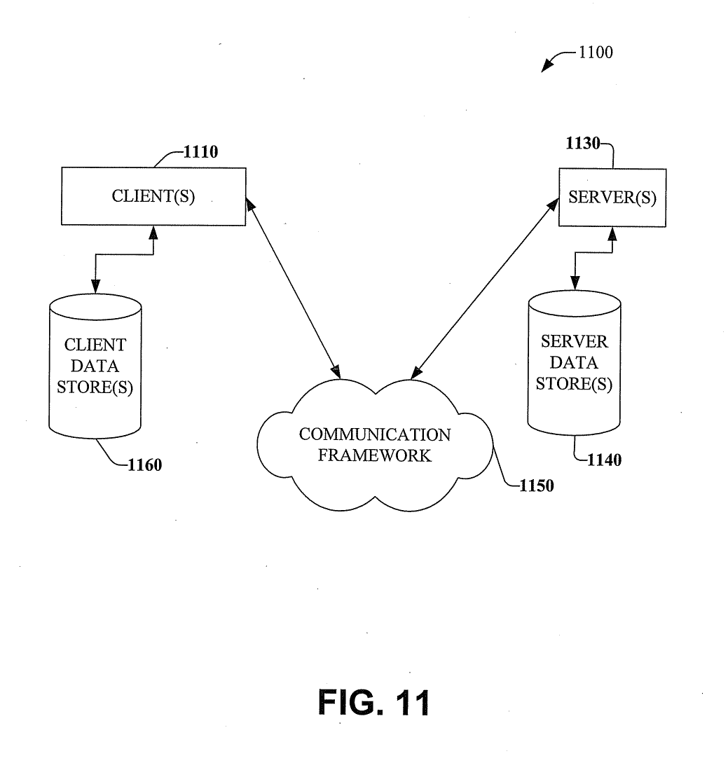

FIG. 11 is a schematic block diagram of a sample-computing environment 1100 with which the disclosed subject matter can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the subject invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130

As mentioned above, while exemplary embodiments have been described in connection with various computing devices and network architectures, the underlying concepts may be applied to any network system and any computing device or system in which it is desirable to implement generation of jog requests and according generation of control signals based thereon.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component”, “module”, “system”, and the like, are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

In addition to the various embodiments described herein, it is to be understood that other similar embodiments can be used or modifications and additions can be made to the described embodiment(s) for performing the same or'equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A method, comprising:
identifying a reward applicable for association with a defined level of contribution of a financial plan;
defining a rule for establishing the defined level of contribution of the financial plan has been met;
determining the rule for the defined level of contribution has been satisfied; and
providing, in response to determining the rule has been satisfied, the reward.

2. The method of claim 1, further comprising capturing data associated with a recipient of the reward.

3. The method of claim 2, further comprising identifying a provider of the reward.

4. The method of claim 3, further comprising forwarding the data associated with the recipient of the reward to the provider of the reward.

5. The method of claim 1, wherein the financial plan is a retirement plan.

6. The method of claim 1, further comprising associating a unique identifier with the reward facilitating tracking of the reward.

7. The method of claim 6, further comprising utilizing the reward unique identifier to associate the recipient of the reward with the reward.

8. The method of claim 7, further comprising forwarding the reward unique identifier and data associated with the participant to a provider of the reward.

9. The method of claim 8, wherein the provider of the reward provides at least one of a product or service upon receipt of the reward.

10. A system comprising:
A rewards program system configured to:
receive from a third party provider system a reward;
receive from a plan provider system information regarding a financial plan offered by the plan provider system and a level of contribution associated with the financial plan;
associate the reward with the contribution level;
determine a criteria associated with the contribution level; and
forward, in response to the criteria being fulfilled, the reward to a recipient associated with fulfillment of the criteria.

11. The computer-readable non-transitory storage medium of claim 16, the operations further

12. The system of claim 10, wherein the rewards program system is further configured to receive data associated with the recipient.

13. The system of claim 12, wherein the rewards program system is further configured to generate a unique identifier to facilitate identification of the reward.

14. The system of claim 13, wherein the rewards program system is further configured to associate the reward unique identifier with the data associated with the recipient.

15. The system of claim 14, wherein the rewards program system is further configured to forward the unique identifier and the data associated with the recipient to the third party provider system.

16. A system, comprising:
a processor;
a computer-readable non-transitory storage medium operationally coupled to the processor and storing computer executable instructions, the computer executable instructions, in response to execution by the processor, implement operations, comprising:
identifying a reward applicable for association with a defined level of contribution of a financial plan;
defining a rule for establishing the defined level of contribution of the financial plan has been met;
determining the rule for the defined level of contribution has been satisfied; and
providing, in response to determining the rule has been satisfied, the reward.

17. The computer-readable non-transitory storage medium of claim 16, the operations further comprising capturing data associated with a recipient of the reward.

18. The computer-readable non-transitory storage medium of claim 17, the operations further comprising identifying a provider of the reward.

19. The computer-readable non-transitory storage medium of claim 18, the operations further comprising forwarding the data associated with the recipient of the reward to the provider of the reward.

20. The computer-readable non-transitory storage medium of claim 18, wherein the financial plan is a retirement plan.
